(19) United States
(12) Patent Application Publication
(10) Pub. No.: US 2007/0250527 A1
(43) Pub. Date: Oct. 25, 2007

(54) Mechanism for abridged indexes over XML document collections

(76) Inventors: Ravi Murthy, Fremont, CA (US); Sivasankaran Chandrasekar, Palo Alto, CA (US); Nipun Agarwal, Santa Clara, CA (US)

Correspondence Address: HICKMAN PALERMO TRUONG & BECKER/ORACLE, 2055 GATEWAY PLACE, SUITE 550, SAN JOSE, CA, 95110-1089, US

(21) Appl. No.: 11/407,663

(22) Filed: Apr. 19, 2006

(51) Int. Cl. G06F 7/00

(52) U.S. Cl. 707/102

(57) ABSTRACT

Techniques are provided for indexing XML documents using abridged indexes. According to one embodiment, a value index is created for each node of an XML documents as specified by one or more criteria. The criteria are used to determine one or more paths of XML documents. For each path specified, a abridged index is created and maintained. When processing a query in a DBMS that utilizes abridged indexes the abridged indexes are used instead the XML index, provided the abridged index can satisfy the query. Use of the abridged indexes improves the efficiency of XPath queries performance.

### RELATED APPLICATION

This application is related to U.S. patent application Ser. No. 10/884,311, (Attorney Docket No. 50277-2512) entitled Index For Accessing XML Data, filed on Jul. 2, 2004 by Sivasankaran Chandrasekara, the contents of which are herein incorporated by reference in their entirety for all purposes.

### FIELD OF THE INVENTION

The present invention relates to indexing XML data, and in particular, using indexes to more efficiently access XML data.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Many database systems allow storage and querying of XML data. Though there are evolving standards for querying XML, many of them include some variation of XPath. However, database systems are usually not optimized to handle XPath queries, and the query performance of the database systems leaves much to be desired. One solution for efficiently satisfying XPath queries involves providing indexes built over XML data (referred to herein as an “XML indexes”). The XML indexes provide efficient access to the XML data by indexing paths and values associated with an XML document.

However, the performance of the XML index does not yet match that of the relational B-Tree Index. The primary reason is that a B-Tree index created on a relational column indexes values only within the column. In contrast, the XML index indexes values corresponding to many different paths and value types. XML indexes may contain all paths and value types associated within an XML document, not just the values within a particular element or attribute.

In order to satisfy queries against any node and to retrieve fragments of an XML document fast, XML indexes track all the nodes of all the XML documents. The size of these indexes is substantial and can impair query execution performance greatly.

### DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating steps for processing a query according to an embodiment of this invention; and

FIG. 2 is a block diagram of a system upon which the techniques described herein may be implemented.

### DETAILED DESCRIPTION

In the following description, for the purposes of explanation, numerous specific details are set forth in order to provide a thorough understanding of various embodiments of the invention. It will be apparent, however, that the present invention may be practiced without these specific details. In other instances, well-known structures and devices are shown in block diagram form in order to avoid unnecessarily obscuring the present invention.

### Functional Overview

A mechanism is provided for improving performance of queries over XML data using abridged indexes that index only a portion of the nodes in the XML data. The mechanism may be used regardless of the format and data structures used to store the actual XML data (the “base structures”). For example, the actual XML data can reside in structures within or outside of a database, in any form, such as CLOB (character LOB storing the actual XML text), O-R (object relational structured form in the presence of an XML schema), or BLOB (binary LOB storing some binary form of the XML).

The techniques described herein involve using a set of structures, which constitute one or more indexes that index nodes in a collection of XML documents and one or more abridged indexes that index a smaller subset of the nodes. In one embodiment, a mechanism is provided by which a user may specify indexing rules that determine which subset of nodes in an XML document are to be stored in the abridged index. Specifically, a user may register one or more XML paths or a monitoring system can register one or more paths to be indexed in the abridged index. For each set of indexing rules specified, an abridged index corresponding to the path is created and maintained as documents are added to the indexed collection.

In one embodiment, the abridged indexes contain a specified subset of nodes, resulting in one or more of the following benefits: (1) Improved search performance of XPath-based queries, (2) Enabling customizations of what values are stored in the index.

### Hierarchy Nature of XML Data

XML documents are represented as a hierarchy of nodes that reflects the XML documents hierarchical nature. The structure of an XML document establishes parent-child relationships between the nodes within the XML document. A hierarchy of nodes is composed of nodes at multiple levels. Each node at a level below the top level is a child node of one or more of the parent nodes at the level above. Nodes at the same level are siblings. A node that has no parent node linked to it is the root node, and a node that has no child nodes linked to it is a leaf node. The “path” for a node in an XML document reflects the series of parent-child links, starting from a “root” node, to arrive at the particular node.

For the purpose of explanation, consider the following XML document:

Po1.xml

<PurchaseOrder>

<Reference>ABEL-20021127121040897PST</Reference>
<Actions>

<Action>

<User>ZLOTKEY</User>

</Action>
<Action>

<User>KING</User>

</Action>

</Actions>

. . . .
</PurchaseOrder>

The path to the “User” node in pol.xml is /PurchaseOrder/Actions/Action/User, since the “User” node is a child of the “Action” node, the “Action” node is a child of the “Actions” node, and the “Actions” node is a child of the “PurchaseOrder” node. PurchaseOrder is the root node.

An XML index may be built on all of the paths within all of the indexed XML documents, or a subset of the paths within the indexed XML documents. Techniques for specifying which paths are indexed are described hereafter. The set of paths that are indexed by a particular XML index are referred to herein as the “indexed XML paths”.

### The XML Index

According to one embodiment, an XML index is a domain index that improves the performance of queries that include XPath-based predicates and/or XPaths-based fragment extraction. An XML index can be built, for example, over both XML Schema-based as well as schema-less XMLType columns which are stored either as CLOB or structured storage. In one embodiment, an XML index is a logical index that results from the cooperative use of a path index, a value index, and an order index.

The path index provides the mechanism to lookup fragments based on simple (navigational) path expressions. The value index provides the lookup based on value equality or range. There could be multiple secondary value indexes—one per datatype. The order index associates hierarchical ordering information with indexed nodes. The order index is used to determine parent-child, ancestor-descendant, and sibling relationships between XML nodes.

### The Path Table

According to one embodiment, an XML index includes a PATH table, and a set of secondary indexes that index the entries in the PATH table. As mentioned above, each indexed XML document may include many indexed nodes. The PATH table contains one row per indexed node. For each indexed node, the PATH table row for the node contains various pieces of information associated with the node.

According to one embodiment, the information contained in each row of the PATH table includes (1) a PATHID that indicates the path to the respective node, (2) “location data” for locating the fragment data for the respective node within the base structures, and (3) “hierarchy data” that indicates the position of the respective node within the structural hierarchy of the XML document that contains the respective node. Optionally, the PATH table may also contain value information for those nodes that are associated with values.

### The General Value Indexes

Some nodes within an indexed document may be attribute nodes or nodes that correspond to simple elements. For attribute nodes and simple elements, the PATH table row also stores the actual value of the attributes and elements. Such values may be stored, for example, in a “value column” of the PATH table.

A separate general value index is built for each data type stored in the value column. Thus, in an implementation in which the value column holds strings, numbers and timestamps, the following value (secondary) indexes are also created:
STRING_INDEX on SYS_XMLVALUE_TO_STRING(value)
NUMBER_INDEX on SYS_XMLVALUE_TO_NUMBER(value)
TIMESTAMP_INDEX on SYS_XMLVALUE_TO_TIMESTAMP(value)

These general value indexes are used to perform datatype based comparisons (equality and range). For example, the NUMBER value index is used to handle number-based comparisons within user XPaths. Entries in the NUMBER_INDEX may, for example, be in the form (number, rowid), where the rowid points to a row, within the PATH table, for a node associated with the value of “number”. Similarly, entries within the STRING_INDEX may have the form (string, rowid), and entries within the TIMESTAMP_INDEX may have the form (timestamp, rowid).

The format of the values in the PATH table may not correspond to the native format of the data type. Therefore, when using the general value indexes, the database server may call conversion functions to convert the value bytes from stored format to the specified datatype. In addition, the database server applies any necessary transformations, as shall be described hereafter. According to one embodiment, the conversion functions operate on both RAW and BLOB values and return NULL if the conversion is not possible.

By default, the general value indexes are created when the XML index is created. However, users can suppress the creation of one or more of general value indexes based on the knowledge of query workload. For example, if all XPath predicates involve string comparisons only, the NUMBER and TIMESTAMP value indexes can be avoided.

### The Abridged Indexes

Just as queries based on path lookups can be accelerated using the PATHID_INDEX, performance of queries based on value lookups can be accelerated by secondary indexes built on the value column of the PATH table. The value columns of the PATH table stores the scalar value for leaf nodes of the XML document. This means the value column of the PATH table holds values for a variety of data types and variety of path expressions. Therefore, according to one embodiment, a separate abridged index is built for a specified subset of nodes (subtrees) in the XML document.

According to one embodiment, a mechanism is provided by which a user may specify indexing rules that describe and/or define which nodes in XML documents are to be indexed in an abridged index. For example, a user may register with a DBMS that stores XML documents certain paths that define what nodes to index, or the DBMS may automatically determine a certain set of XML paths for abridged indexing. For each specified path, an abridged index is created based on the values corresponding to the path

According to one embodiment, the user can explicitly specify the set of nodes (subtrees) that are to be included in the abridged index. Alternatively, the set of nodes to be included can be determined automatically from a system monitoring application as explained in greater detail later. Both the explicit and automatic methods for specifying a set of nodes for value indexing are typically used to include fragments that are known to be queried frequently. These abridged indexes are also smaller then the general value index, since each abridged index corresponds to fewer XML paths.

According to one embodiment, an initial registration of paths may occur at the time the index is created. In another embodiment of this invention, the registration of the paths can occur after the creation of the index. The user can expressly specify the subset of nodes in XML documents to be indexed by providing a subset of XPaths. Alternatively, a monitoring system can determine a subset of XPaths based on observing applications over a period of time and determining which paths are used most frequently. For each of the paths contained in the specified subset, an abridged index is created. This abridged index may be another secondary B-Tree index on a value column of the path table. However, the abridged index only indexes the values corresponding to nodes identified by the specified subset of paths. For all other nodes, the value is assumed to be NULL and is omitted from the abridged index. For example:

| XML Index table could be as follows | |
|---|---|
| ROWID, (Document-ID, Path, Value) | |
| 1, | (1, /Emp, null) |
| 2, | (1, /Emp/EmpNo, 123) |
| 3, | (1, /Emp/Salary, 10000) |
| 4, | (2, /Emp, null) |
| 5, | (2, /Emp/EmpNo, 124) |
| 6, | (2, /Emp/Salary, 11000) |
| ... | |

The general VALUE index contains the following entries.
(key, rowid)
(123, 2)
(124, 5)
(10000, 3)
(11000, 6)
...
A abridged index on /Emp/Salary contains the following entries.
(key, rowid)
(10000, 3)
(11000, 6)
...

### Query Processing Using Abridged Indexes

When a user submits a query using XPath predicates, the query is first analyzed by the DBMS to see if the XML index can be used. Then, the DBMS determines if any of the abridged indexes can be used instead of the general value index. This determination is made by applying the XPath expression in the query with the subset of XPaths used to build the abridged indexes. For example, if the user query is /Emp[Salary&gt; 10000], the abridged index built on /Emp/Salary can be used. If an abridged index has been built for //c, it can be used for user query such as /a/b[c &gt; 10]. If a abridged index has been built for /a/*, it can be used for user query such as /a/[b &gt; 5]

At query execution time, the abridged index is accessed instead of the general value index. This leads to performance improvements because the abridged index is smaller, hence fewer disk accesses and thus improved query performance.

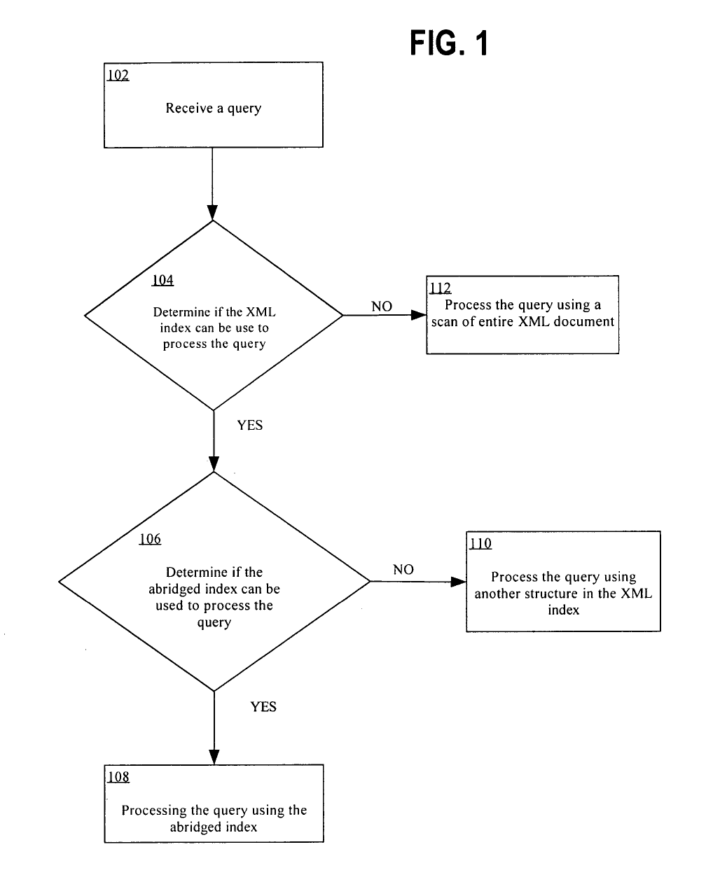

FIG. 1 illustrates the steps for executing a query over an XML document, which use an abridged index. In step 102, a query is received by the DBMS. In step 104, the query is analyzed to determine if the XML index can be used. If the XML index can be used then in step 106 the DBMS compares the query to the specified subset of paths to determine if an abridged index can be used or if the general value index should be used. An abridged index can be used if the DBMS determines that the abridged index contains a superset of the query XPath. If the DBMS determines that the abridged index can be used, then in step 108 the abridged index is used to execute and return the result of the query. If in step 110, the abridged index cannot be used, but another structure within the XML index (e.g. generalized value index, path table) can be used, then the query is performed using the other structure. If both the abridged index and the XML index cannot be used to process the query then in step 112 the query is processed by performing a full scan of the XML document.

### Use of Wildcarding to Determine which Paths to Index

According to one embodiment, the user can include a wildcard symbol in the paths registered as indexing rules. The rule /PurchaseOrder/LineItems//* includes a wildcard symbol “*”. Consequently, the rule expressly includes the path /PurchaseOrder/LineItems and the path to all nodes that descend from the path /PurchaseOrder/LineItems. This is merely one example of how wildcards may be used in the indexing rules. According to one embodiment, the indexing rule mechanism supports wildcards in any number of contexts. For example, the rule /nodex/*/nodey/nodez selects all paths that (1) descend from /nodex/ and (2) terminate in /nodey/nodez, regardless of the path between nodex and nodey/nodez.

### Hardware Overview

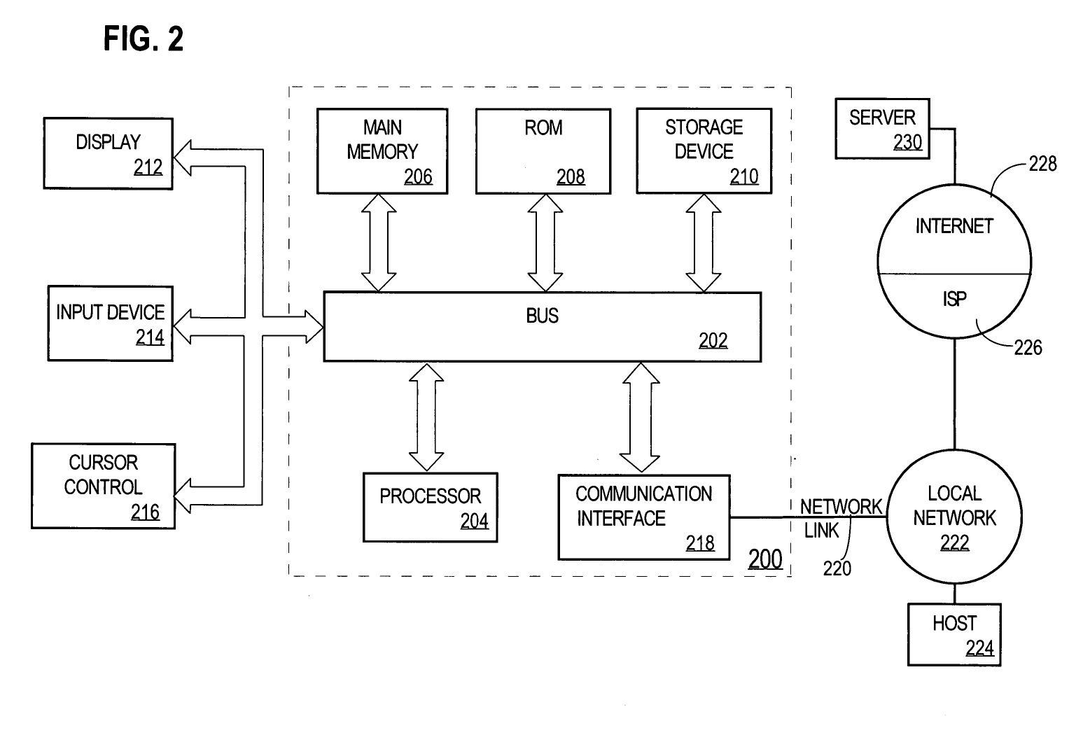

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 200, various machine-readable media are involved, for example, in providing instructions to processor 204 for execution. Such a medium may take many forms, including but not limited to, non-volatile media, volatile media, and transmission media. Non-volatile media includes, for example, optical or magnetic disks, such as storage device 210. Volatile media includes dynamic memory, such as main memory 206. Transmission media includes coaxial cables, copper wire, and fiber optics, including the wires that comprise bus 202. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for indexing a collection of XML documents, the method comprising:
for a set of nodes in the collection of XML documents, using a first index to index the set of nodes;
building a second index of the first index; and
based on one or more criteria, determining which subset of nodes of said set of nodes to index in said second index.

2. The method of claim 1 wherein the one or more criteria corresponds to a set of path expressions.

3. The method of claim 1 wherein the one or more criteria is determined based on user specified input.

4. The method of claim 1 wherein the one or more criteria is determined based on monitoring queries issued against said collection of XML documents.

5. The method of claim 4 wherein monitoring queries issued against said collection of XML documents includes, monitoring usage and performance of operations executed on the collection of XML documents.

6. The method of claim 1 wherein determining which subset of nodes of said set of nodes to index includes:
determining whether a first node contained in the collection of XML documents satisfies said one or more criteria; and
if said first node satisfies said one or more criteria, then adding the first node to the second index.

7. The method of claim 1 wherein the second index indexes the corresponding values in the subset of nodes of said set of nodes.

8. The method of claim 1 wherein the first index and the second index are maintained by a database management system.

9. The method of claim 8 wherein the database management systems receives DDL statements representing the one or more criteria for determining which subset of nodes of said set of nodes to index in said second index.

10. A method for determining whether one or more indexes can be used to process a query comprising the steps of:
determining whether a first index can be used to process the query, and wherein said first index indexes a second index of node within a collection of XML documents, wherein the first indexes a subset of the nodes indexed by said second index, said subset being determined by the one or more criteria, and if said first index can be used to process the query, computing the query based on said first.

11. The method of claim 10 wherein the step of determining whether the first index can be used to process the query further comprises comparing a first path expression from the query to the one or more criteria.

12. A computer-readable medium carrying one or more sequences of instructions, which, when executed by one or more processors, causes the one or more processors to perform the method recited in claim 1.

13. A computer-readable medium carrying one or more sequences of instructions, which, when executed by one or more processors, causes the one or more processors to perform the method recited in claim 2.

14. A computer-readable medium carrying one or more sequences of instructions, which, when executed by one or more processors, causes the one or more processors to perform the method recited in claim 3.

15. A computer-readable medium carrying one or more sequences of instructions, which, when executed by one or more processors, causes the one or more processors to perform the method recited in claim 4.

16. A computer-readable medium carrying one or more sequences of instructions, which, when executed by one or more processors, causes the one or more processors to perform the method recited in claim 5.

17. A computer-readable medium carrying one or more sequences of instructions, which, when executed by one or more processors, causes the one or more processors to perform the method recited in claim 6.

18. A computer-readable medium carrying one or more sequences of instructions, which, when executed by one or more processors, causes the one or more processors to perform the method recited in claim 7.

19. A computer-readable medium carrying one or more sequences of instructions, which, when executed by one or more processors, causes the one or more processors to perform the method recited in claim 8.

20. A computer-readable medium carrying one or more sequences of instructions, which, when executed by one or more processors, causes the one or more processors to perform the method recited in claim 9.

21. A computer-readable medium carrying one or more sequences of instructions, which, when executed by one or more processors, causes the one or more processors to perform the method recited in claim 10.

22. A computer-readable medium carrying one or more sequences of instructions, which, when executed by one or more processors, causes the one or more processors to perform the method recited in claim 11.
